(19) United States
(12) Patent Application Publication
(10) Pub. No.: US 2011/0126593 A1
(43) Pub. Date: Jun. 2, 2011

(54) APPARATUS AND METHOD FOR SEPARATING A GLASS SHEET

(76) Inventors: Rashid Abdul-Rahman, Horseheads, NY (US); Gautam Narendra Kudva, Horseheads, NY (US); Yukio Yuhara, Sakai City (JP)

(21) Appl. No.: 12/627,326

(22) Filed: Nov. 30, 2009

(51) Int. Cl. C03B 21/02

(52) U.S. Cl. 65/97; 65/174

(57) ABSTRACT

A method of separating a moving glass ribbon to form an individual sheet of glass is disclosed comprising a plurality of nosing members that move in a direction and at a speed that the moving glass ribbon is moving. The nosing members can be positioned independently of each other, and can be positioned adjacent to but not in contact with the ribbon during the scoring operation to restrict out-of-plane movement of the glass ribbon (movement substantially transverse to the draw direction of the ribbon) during the separation phase of the process.

### TECHNICAL FIELD

This invention is directed to a method of separating a moving glass ribbon to obtain an individual glass sheet through the use of a nosing assembly disposed above a score line. A nosing apparatus is also disclosed.

### BACKGROUND

One method of forming a thin sheet of glass is by a drawing process where a ribbon of glass is drawn from a reservoir of molten glass. This may be accomplished, for example, via an up-draw process, where the ribbon is drawn upward from the reservoir (e.g. Foucault or Colburn), or by a down-draw process (e.g. slot or fusion), where the ribbon is drawn downward, typically from a forming body. Once the ribbon is formed, individual sheets of glass are cut from the ribbon.

In a typical downdraw method, the ribbon of glass undergoes a change from a viscous state to an elastic state. As the ribbon passes through an intermediary visco-elastic state, stress that may be imposed on the ribbon takes an increasingly longer time to be relieved, until a point is reached when the imposed stress (either thermal or mechanical) can not be relieved within a practical amount of time and becomes frozen into the ribbon. This frozen-in stress can significantly impact the shape of glass sheets cut from the ribbon. Thus, it is important that imposed stress be minimized during this transition period.

### SUMMARY

As the size requirements for glass sheets, and particularly glass sheets destined for use in display type applications, grow ever larger, the ability to handle such large, thin portions of glass becomes increasingly more difficult. This is especially true for downdraw processes, such as the fusion process, and particularly during the cutoff operation where an individual sheet of glass is separated from the moving ribbon of glass descending from the forming apparatus. In the cutoff, or separation process, vibrations or other induced motion in the ribbon caused by the scoring and separation during its descent can propagate upward into the visco-elastic region of the ribbon and be frozen into the ribbon as unwanted residual stress or shape. To avoid such artifacts, a nosing assembly is described that can be used to minimize movement in the ribbon in the elastic region of the glass from propagating into the visco-elastic region.

In one embodiment, a method of separating a glass sheet from a moving ribbon of glass is disclosed comprising forming a moving glass ribbon having first and second major sides and comprising a viscous portion and an elastic portion. The glass moves in a substantially vertical direction due to the force of gravity and the effect of pulling rollers that engage with the ribbon and pull it downward from a forming body. The ribbon is a continuously moving ribbon of glass in that as long as a continuous supply of molten glass is provided to the forming body, a ribbon of glass is drawn from the forming body.

The method further comprises contacting the first side of the elastic portion of the moving ribbon of glass with an anvil contact member, the anvil contact member moving in a direction and at a speed equal to a direction and speed of the moving ribbon of glass. This motion of the anvil contact member in a direction and at a speed substantially equal to the direction and speed of the vertically moving glass ribbon as it descends from the forming body allows for a later score line to be made in a transverse direction across a width of the glass ribbon.

According to the present embodiment, a plurality of nosing contact members are positioned in an opposing relationship to the second side of the moving ribbon of glass upstream from the anvil contact member and the second side of the glass ribbon is scored across a width of the glass ribbon opposite the anvil member to form a score line in the second side. An individual glass sheet is then separated from the moving glass ribbon at the score line by producing a tension stress across the score line. The tension stress can be produced, for example, by applying a bending moment to the glass ribbon, or by applying a downward force to the ribbon below the score line.

Prior to the scoring operation each nosing contact member of the plurality of nosing members is positioned a pre-determined distance from the moving glass ribbon so that none of the plurality of nosing members is in contact with the moving glass ribbon during the scoring, but such that lateral displacement of the moving ribbon of glass between the anvil contact member and the plurality of nosing contact members is constrained to a predetermined maximum during the separating. This predetermined maximum distance between a nosing member and the second surface of the glass ribbon may be, for example, equal to or less than about 5 mm. In some cases, the pre-determined maximum distance between a nosing member and the second side of the moving glass ribbon may be between 2 mm and 5 mm.

The positioning step may comprise, for example, moving at least one nosing contact member of the plurality of nosing contact members from a rest position to the predetermined position at a pre-determined distance from the second surface of the moving ribbon of glass. That is, the nosing contact member is first in a rest or docked position, then moved forward to within a predetermined distance (e.g. > and ≦5 mm) from the second surface of the moving glass ribbon.

The method may further comprise moving at least one nosing contact member of the plurality of nosing members from the predetermined position to the rest or docked position after the step of separating has been completed.

In some instances, the plurality of nosing contact members are coupled to a frame and the positioning comprises moving the frame to simultaneously move the plurality of nosing contact members. This may be accomplished in conjunction with moving each nosing contact member individually, or even moving groups of nosing members comprising some but not all nosing contact members of the plurality of nosing members.

In some embodiments, the plurality of nosing contact members is arrayed in a straight line (linearly) across a width of the moving glass ribbon. That is, each nosing contact member of the plurality of nosing contact members is positioned at the same vertical height as the rest of the nosing contact members.

In other embodiments, the plurality of nosing contact members are arrayed vertically staggered across a width of the moving ribbon of glass so that one nosing member of the plurality of nosing contact members is vertically offset from another nosing member. In this configuration, one nosing contact member may be at one vertical height, whereas a second nosing member may be positioned at a second vertical height different from the first nosing contact member. This offset may be between two non-adjacent nosing contact members, or relative to two adjacent nosing members.

In still another embodiment, a method of separating a glass sheet from a moving ribbon of glass is described comprising forming a moving glass ribbon having first and second major sides and comprising a viscous portion and an elastic portion, contacting the first side of the elastic portion of the moving ribbon of glass with an anvil contact member, the anvil contact member moving in a direction and at a speed substantially equal to a direction and speed of the moving ribbon of glass and positioning a plurality of nosing contact members in an opposing relationship to the second side of the moving ribbon of glass upstream from the anvil contact member.

Once the nosing contact members are positioned, the second side of the glass ribbon is scored across a width of the glass ribbon opposite the anvil contact member to form a score line, and a glass sheet from the moving glass ribbon at the score line by producing a tension stress across the score line. The tension stress may be produced, for example, by applying a bending moment to the moving glass ribbon or by applying a downward pulling force to the moving glass ribbon below the score line. According to the present embodiment at least one nosing contact member of the plurality of nosing contact members is in contact with the moving glass ribbon during the scoring, but not all of the nosing contact members of the plurality of nosing contact members are in contact with the moving ribbon of glass during the scoring.

For example, one or more nosing contact members of the plurality of nosing contact members may be positioned in contact with the moving glass ribbon, still moving in a direction and at a speed equal to the direction and speed at which the ribbon is moving, and one or more nosing contact members of the plurality of nosing contact members are positioned a pre-determined distance from the second surface of the moving glass ribbon, and moving in a direction and at a speed substantially equal to the speed and direction of the moving glass ribbon. Thus, a portion of the plurality of nosing contact members serve as damping members to prevent upward propagation of vibration induced in the ribbon during the scoring and/or separation operation, while the nosing contact members positioned a predetermined distance from the second surface of the moving glass ribbon serve as limiters to limit swinging of the ribbon after the separation operation.

In yet another embodiment, an apparatus for separating a sheet of glass from a moving glass ribbon is disclosed comprising a forming body supplying a continuously moving glass ribbon that transitions from a viscous state to an elastic state, a carriage assembly that moves in a direction and at a speed substantially equal to a direction and speed of the moving glass ribbon, an anvil contact member configured to move in a direction and at a speed substantially equal to a direction and speed of the moving ribbon of glass, a plurality of nosing contact members arrayed across a width of the glass ribbon, each nosing contact member of the plurality of nosing contact members configured to move toward or away from the glass ribbon independently from an adjacent nosing contact member, and wherein each nosing contact member is unconnected from an adjacent nosing contact surface.

The apparatus may further comprise a carriage assembly coupled to the plurality of nosing members to move the plurality of nosing members in a direction and at a speed substantially equal to the direction and speed of the moving glass ribbon.

It should be noted that movement of the individual nosing contact members can be separately timed, so that each individual nosing contact member can be actuated to extend or withdraw at different times. Thus, in the instance where an individual nosing contact member is intended to contact the moving glass ribbon, nosing member movement can be orchestrated, such as via computer control, to contact or disengage from the ribbon at different times, depending on need.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods, features and advantages be included within this description, be within the scope of the present invention, and be protected by the accompanying claims.

### BRIEF DESCRIPTION OF THE DRAWINGS

FIG. 1 is a front elevation view of an exemplary fusion downdraw apparatus for forming a thin glass ribbon showing the placement of the separation assembly for producing a glass sheet from the ribbon.

FIG. 2 is a side view of an edge of the glass ribbon produced from a downdraw process, and showing the arrangement of the anvil, scoring and nosing assemblies.

FIG. 3 is a top view of a portion of the separation assembly of FIG. 1 illustrating exemplary anvil, scoring and nosing assemblies.

FIG. 4 is a side view of an edge of the glass ribbon showing the arrangement of the anvil, scoring and nosing assemblies relative to the glass ribbon, and depicting an embodiment where the nosing members of the nosing assembly are offset vertically.

FIG. 5 is a front view of the moving ribbon of glass slowing a non-linear array of nosing members across at least a portion of a width of the moving glass ribbon, wherein at least one nosing member (and its associated nosing contact member) is vertically offset from an adjacent nosing member.

FIGS. 6A-6D illustrate a sequence of steps as the anvil assembly, scoring assembly and nosing assembly are actuated to move in, and move away from the moving glass ribbon as the ribbon is contacted by the anvil assembly, scored by the scoring assembly and constrained from excessive movement by the nosing assembly.

FIG. 7 is a top view of the anvil assembly and the nosing assembly, shown with the anvil assembly engaged with the moving glass ribbon, and the nosing members arrayed across a width of the moving glass ribbon, and wherein nosing contact members are positioned to have a shape complimentary to the curvature of the ribbon across the ribbon width.

FIG. 8 is a top view of the anvil assembly and the nosing assembly wherein the distance between the nosing contact members and the moving glass ribbon is different between nosing members.

FIG. 9 is a top view of the anvil assembly and the nosing assembly wherein at least one, but not all, of the nosing contact members are in contact with the moving glass ribbon as the moving glass ribbon is scored.

FIG. 10 is a top view of the anvil assembly and the nosing assembly wherein all of the nosing contact members are in contact with the moving glass ribbon as the moving glass ribbon is scored.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

Drawing a thin ribbon of material to form a glass sheet having a thickness less than about a millimeter to the exacting standards of flatness required for modern display applications, such as televisions and computer monitors, requires careful control of all aspects of the manufacturing process. However, particular attention must be paid to the period of time during which the glass ribbon is transitioning from a viscous state to an elastic state. Even small force variations on the ribbon, such as might be produced by air currents in the drawing area, or vibrations from running equipment, can manifest as perturbations in what should be a pristine, flat surface.

In an exemplary fusion-type downdraw process, molten glass is supplied to a forming body comprising a channel open at its top in an upper surface of the body. The molten glass overflows the walls of the channel and flows down converging outside surfaces of the forming body until the separate flows meet at the line along which the converging surfaces meet (i.e. the “root”). There, the separate flows join, or fuse, to become a single ribbon of glass that flows downward from the forming body. Various rollers (or “rolls”) positioned along the edges of the ribbon serve to draw, or pull the ribbon downward and/or apply a tensioning force to the ribbon that helps maintain the width of the ribbon. That is, some rolls may be rotated by motors, whereas other rolls are free-wheeling.

As the ribbon descends from the forming body, the molten material transitions from a viscous state at the bottom of the forming body, to a visco-elastic state and finally to an elastic state. When the ribbon has cooled to an elastic state, the ribbon is scored across its width, and separated along the resultant score line to produce a separate glass sheet.

During the time the ribbon is in a fluid, viscous state, stresses imposed on the molten material are immediately relieved. However, as the ribbon cools and the viscosity increases, induced stresses are not so quickly relieved, until a temperature range is reached when induced stresses or shape changes (e.g. warping) may be retained by the glass when it has cooled to an elastic state. During this period in the visco-elastic region, and more specifically during the glass transition temperature range when stress and shape can be frozen into the glass, forces imposed onto the glass ribbon should be minimized.

One source of stress and/or shape change is movement of the glass ribbon that can occur during the process of separating an individual glass sheet from the moving ribbon of glass. In a typical downdraw process, the ribbon is first scored, often by a mechanical scoring device that contact the ribbon. Once a score line is formed, a bending moment is applied to the ribbon to produce a tension stress across the score line until the ribbon separates along the score line. Such “score and snap” methods result in an energy release when the ribbon separates that can incur in lateral movement of the ribbon. That is, a swinging movement substantially orthogonal to the two major faces or sides of the ribbon may occur. This swinging movement, as well as vibrations (such as vibrations associated with the “sound” of the break or fracture) can be translated upward along the ribbon into the visco-elastic region of the ribbon and result in frozen-in residual stress, or as a permanent shape change. A method of limiting this lateral swinging movement, and an apparatus therefor, is proposed.

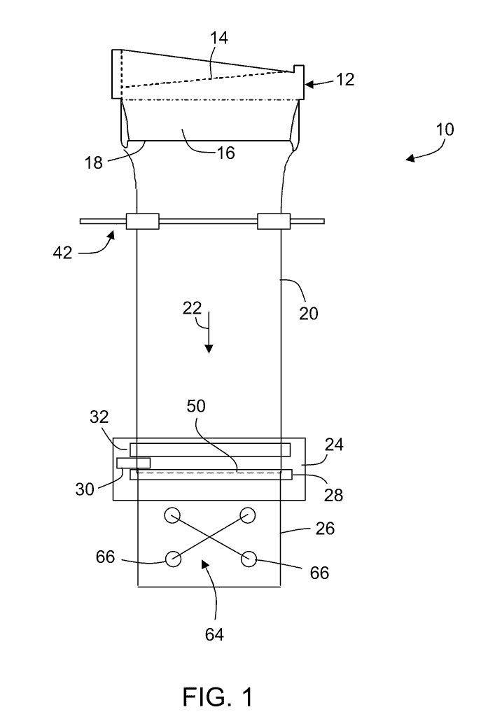

Shown in FIG. 1 is an exemplary fusion downdraw apparatus 10 comprising forming body 12 including channel or trough 14 and converging forming surfaces 16. Converging forming surfaces 16 meet at root 18. Trough 14 is supplied from a source (not shown) with molten glass that overflows the walls of the trough and descends over the outer surfaces of the forming body as separate streams. The separate streams of molten glass flowing over converging forming surfaces 16 join at root 18 and form glass ribbon 20 that is drawn vertically downward, as indicated by arrow 22. Thus, the portion of the separate glass flows that were in contact with the sides of the forming body becomes the interior portion of the resultant ribbon, and the outer surfaces of the ribbon are pristine and substantially free from particulate or other defects that may be caused by the flow over the forming surfaces.

When glass ribbon 20 has reached a final thickness and viscosity, the ribbon is separated across its width using separation assembly 24 to provide an independent glass sheet or pane 26. As molten glass continues to be supplied to the forming body, and the ribbon lengthens, additional glass sheets are separated from the ribbon.

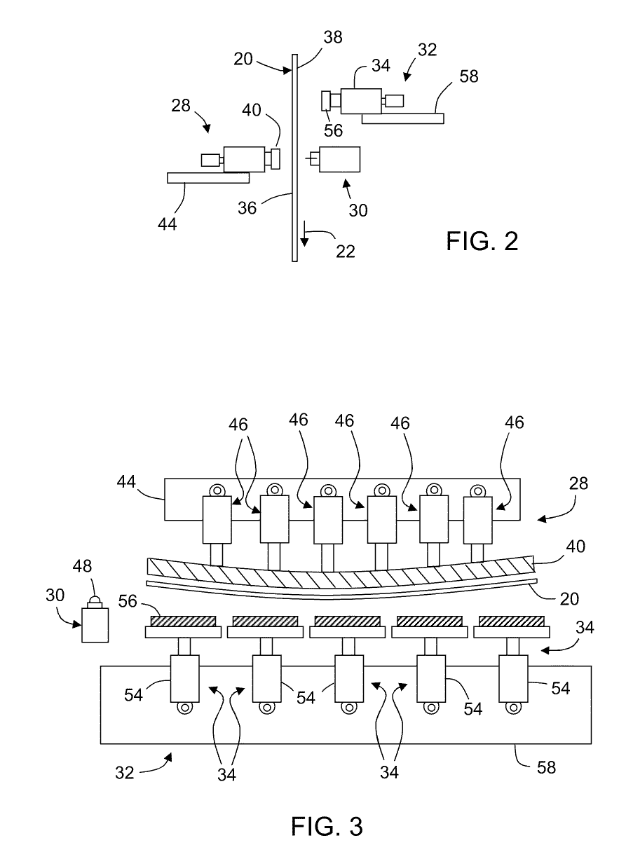

FIG. 2 illustrates a side view of a portion of separation assembly 26 comprising scoring anvil assembly 28, scoring assembly 30 and nosing assembly 32. Nosing assembly 32 in particular comprises a plurality of nosing members 34 arranged in an array across at least a portion of the width of the ribbon, as best shown in FIG. 3, and configured to move independently of each other. Nosing assembly 32 is described in more detail below. Scoring anvil assembly 28 is located adjacent first side 36 of glass ribbon 20, while scoring assembly 30 and nosing assembly 32 are arranged adjacent second side 38 of ribbon 20. Nosing assembly 32 is further positioned upstream of scoring anvil assembly 28. As used herein and unless otherwise indicated, upstream and downstream are relative to the drawing direction of the moving glass ribbon. Accordingly, the term upstream in the present example of a vertical downdraw glass making process where the glass ribbon is pulled vertically downward, upstream of the scoring anvil assembly denotes above the scoring anvil assembly.

Scoring anvil assembly 28 comprises an anvil contact surface or member 40 that extends substantially across the width of the ribbon and is configured to be moved inward toward the ribbon from a resting or docked position and contact the moving ribbon, thereby providing a stable backing to the moving glass ribbon as the scoring device traverses over the second side of the ribbon and forms the score line on the second side. Since contact member 40 is in contact with ribbon 20 during the scoring process, and the ribbon is moving, the anvil contact member is configured to move in a direction and at a speed substantially equal to the direction (e.g. direction 22) and speed of the moving ribbon of glass. For example, in a downdraw glass forming process, the glass ribbon descends in a downward vertical direction at a speed dependent on the action of glass supply rate, gravity and the draw rate of the pulling roller assembly 42. The speed of descent of ribbon 20 can change depending on such factors as the desired thickness of the final glass sheet. A difference between the speed and direction of movement of the scoring anvil assembly and the speed and direction of movement of the glass ribbon can cause unwanted changes in the glass ribbon, and so movement of the ribbon and the anvil contact member are synchronized to move together.

For example, anvil contact member 40 of scoring anvil assembly 28 may be coupled to a carriage assembly 44 through support members 46 that support and position the contact surface. Carriage assembly 44 is configured to move downward a predetermined distance depending on the length of glass sheet 26 to be separated from ribbon 20, and in synchronization with moving ribbon of glass 20 during the scoring operation, then return to the starting position in preparation for the next cycle. Anvil contact member 40 is capable of withstanding prolonged exposure to high temperatures (in some cases at least several hundred degrees centigrade), and is preferably formed from a compliant material to minimize damage to the ribbon from the contact. In some embodiments anvil contact member 40 may comprise a flexible beam, as shown in FIG. 3, that is coupled to carriage assembly 44 through actuator supports 46, such as pneumatic or hydraulic actuators configured to move anvil contact member 40 inward to engage the ribbon, and then withdraw to return anvil contact member 40 to a starting position away from and not in contact with the ribbon. In still other embodiments, the flexible beam may be configured to assume a shape other than a linear shape. For example, the flexible beam portrayed in FIG. 3 is curved to conform to a curvature of moving glass ribbon 20. Alternatively, the anvil contact member may be used to conform the ribbon substantially to a curvature of the anvil contact member. Support members 46 will be assumed to be actuators throughout the present example, although it should be understood that supports 46 could be trusses that rigidly fix the anvil contact member relative to carriage 44.

Scoring assembly 30 may comprise, for example, a scoring member 48 (e.g. carbide steel wheel or tip) that contacts glass ribbon 20 and forms a vent crack across at least a portion of the width of the ribbon on second surface 38. Such scoring devices are well known and will not be described in depth here. However, it should be noted that the conditions described for the anvil assembly apply equally to the scoring assembly. That is, to obtain a score that is perpendicular to the edges of the ribbon, the scoring assembly is configured to travel in a direction and at a speed substantially equal to the direction and speed of the moving ribbon of glass. This movement is in addition to the movement of the scoring device in a transverse direction (across at least a portion of the glass ribbon width) to score the glass ribbon and form score line 50. It should also be noted that in instances where the moving glass ribbon comprises a curvature across a width of the ribbon, scoring assembly 30 may be configured to vary the position of the scoring member as it traverses the curved surface of the glass ribbon. Thus, in some embodiments the scoring member may be extended or retracted as it traverses the width of the glass ribbon to accommodate the relative position of the curved ribbon.

In some embodiments, the scoring device may comprise a laser (not shown), the beam of which forms the score line without physical contact with the glass. Such non-contact scoring devices eliminate vibration or lateral movement of the ribbon that can occur from contact with scoring wheels or tips. However, to obtain a score line that is perpendicular to the edges of the ribbon the laser-based scoring device may be moved in a direction and at a speed substantially equal to the direction and speed of the moving ribbon of glass similar to the movement of the contact type scoring devices.

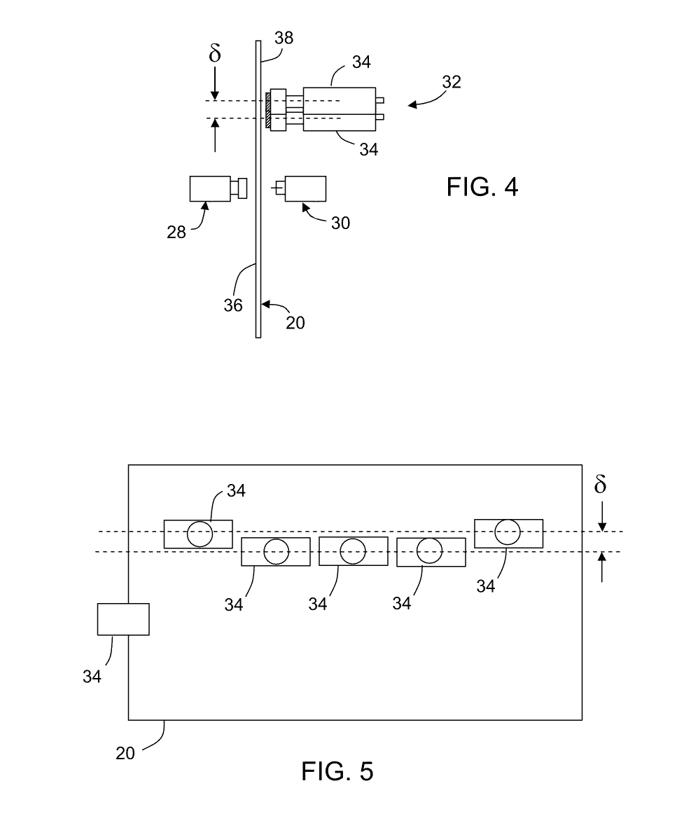

Nosing assembly 32 comprises a plurality of individual nosing members 34. Each nosing member 34 may comprise a nosing actuator 54, such as a pneumatic or hydraulic cylinder configured to move the nosing member independently of the other nosing members. Each nosing member 34 also may include a nosing contact member 56 designed to survive long term exposure to high temperature, and soft enough not to damage the glass ribbon if the nosing contact surface is contacted by the ribbon. The plurality of nosing members 34 may be arrayed in a line in a direction transverse to the direction of movement of the moving ribbon of glass (across at least a portion of the width of the ribbon). However, in some embodiments, the individual nosing members (and their associated nosing contact members) may not be arrayed in a line, but instead staggered, with some nosing members vertically higher or lower than adjacent nosing members according to their position across the width of the ribbon, and need. For example, FIG. 4 illustrates two nosing members 34 offset in the vertical direction by a distance δ in an edge view (relative to the glass ribbon), whereas FIG. 5 depicts a side view of an array of nosing members arranged in a vertically staggered (non-linear) array.

Each nosing actuator 54 may in turn be coupled to a frame 58 that can be moved to provide rough positioning of the plurality of nosing members. For example, frame 58 can first be positioned so the plurality of nosing contact members is in rough proximity to the moving glass ribbon. Frame 58 may also be configured to move the plurality of nosing contact members in vertical synchronization, similar to carriage 44. In this instance frame 58 moves the plurality of nosing members 34 downward in a direction and at a speed substantially equal to the direction and speed of the descending ribbon. Once separation of glass sheet 26 has been performed, frame 58 moves the plurality of nosing members upward to a docked position in preparation for the next cycle. Frame 58 can be positioned, for example, by a mechanical assembly or via one or more remotely activated actuators such as pneumatic or hydraulic cylinders.

Once the nosing contact members are positioned in rough proximity to moving ribbon of glass 20, each actuator 54 may be activated to move its associated nosing contact member 56 to a predetermined distance from a surface of the downward moving glass ribbon. In addition, the tolerance or spacing between the moving glass ribbon and each nosing contact member 56 can be individually adjusted Hence compensation for errors in alignment, tolerance and sheet motion is readily available.

Nosing members 34 may be positioned downstream (relative to the direction of travel of the glass ribbon) of score line 50 or upstream of the score line. However, an upstream placement can better assist in preventing propagation of movement or small vibration upward into the visco-elastic region of the glass ribbon, particularly if the nosing members are in contact with the ribbon. In this regard, nosing members 34 may be moved in a vertical direction (such as by frame 58), upward or downward according to the desired impact on the separation process. For example, a lower setting enables more effective bending separation control, while a setting for a higher position (relative to the score line) enables sheet dampening and a reduction in negative interactions on the forming process control from transverse ribbon movement.

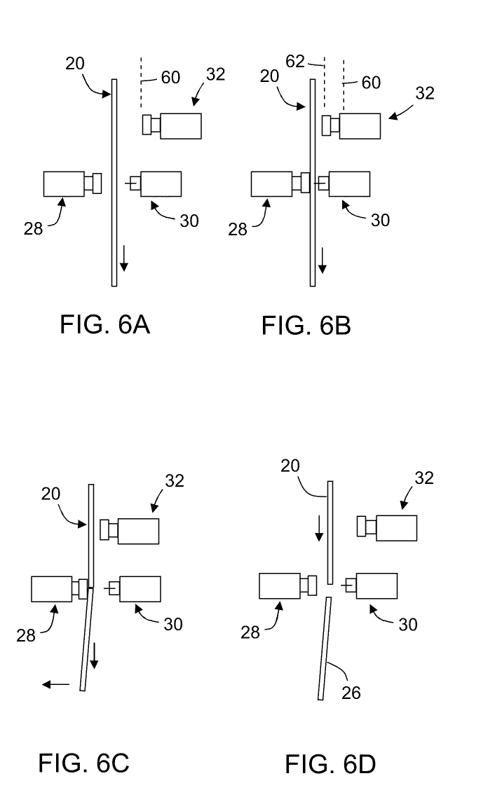

Referring to FIG. 6A-6D, in one embodiment anvil contact surface 40, scoring device 30 and nosing members 34 are positioned so none of the three assemblies is in contact with the moving glass ribbon (FIG. 6A). In FIG. 6B anvil contact member 40 is moved inward to contact glass ribbon 20 as glass ribbon 20 is drawn downward from forming body 12 by pulling roller assembly 42. Frame 58 is similarly moved inward from a first docked position to a second position closer to the ribbon without contacting the glass ribbon with nosing contact members 56. Nosing contact members 56 of nosing members 34 may then be individually positioned at pre-determined distances from the surface of the glass ribbon by extending actuators 54, or the nosing contact members can be pre-positioned prior to movement of frame 58 from the rest or docked position to the second, closer position. For example, a nosing contact member initially at position 60 as shown in FIG. 6A may be extended toward moving glass ribbon 20 to a final position 62 as predetermined distance from second surface 38 of ribbon 20, without contacting ribbon 20, as illustrated in FIG. 6B. Also as shown in FIG. 6B, scoring member 48 is brought into contact with second surface 38 of glass ribbon 20 and moved across at least a portion of the width of ribbon 20. As described above, both the anvil contact member and the plurality of nosing members are moved in a direction and at a speed substantially equal to the direction and speed of the glass ribbon as it is being drawn.

Referring to FIG. 6C, once the individual nosing contact members have been positioned a predetermined distance from the moving glass ribbon and above the scoring device, the scoring device is engaged to contact the glass ribbon at second surface 38 with scoring member 48, and scoring member 48 is moved across the width of the ribbon to form score line 50. Engagement of the scoring device may include contact between scoring member 48 and the moving glass ribbon, such as in the case of a mechanical scoring device, or engagement may include simply positioning of the scoring assembly in an appropriate position in the case of a laser-based scoring device, and, once the laser-based scoring assembly has been positioned, traversing the laser beam produced by the laser across at least a portion of the width of the glass ribbon. In either case, score line 50 is formed on ribbon second side 38. As in the case of the anvil assembly 28 and the plurality of nosing members 34, scoring assembly 30 moves in a direction and at a speed substantially equal to the direction and speed of the moving glass ribbon as the scoring device is concurrently moved across a width of the ribbon.

To apply the tension stress across the scoring line and remove individual glass sheet 26 from moving ribbon of glass 20, manipulator 64 may be used to apply a bending moment to the glass ribbon. The bending creates a tension stress across the score line, thus causing the crack created by the scoring to extend through the thickness of the ribbon and separate the sheet. Alternatively, a downward pulling force may be applied to the ribbon below the score line. Manipulator 64 may include flexible suction cups 66 that secure to a surface of the glass sheet and hold the glass sheet via a vacuum applied to the suction cups with minimal damage to the surface of the glass sheet. Manipulator 64 may be, for example, a robot that performs functions according to instructions programmed into a computer or controller in communication with the controller or computer. Once sheet 26 is separated from ribbon 20, manipulator 60 may then dispose of the sheet as desired. For example, manipulator 60 may stack the glass sheet in a container (not shown) for transportation of the glass sheet to other processing equipment (e.g. edge finishing).

The tensioning operation described above (e.g. bending) stores energy in the moving glass ribbon via the tension stress. Once the glass abruptly separates, this energy is released, causing lateral movement of the ribbon and vibration. That is, glass ribbon 20 may move in a direction substantially perpendicular to the major first and second sides 36, 38 of the ribbon. In short, ribbon 20 may swing (while the swinging more correctly induces an arcuate movement, over short distances this arcing swing can be treated as a lateral translation). As described supra, if unabated this movement can be transmitted into the visco-elastic region of the moving glass ribbon and run the risk of imposing stress changes into the ribbon that become frozen in as the ribbon transitions from a visco-elastic state to an elastic state.

As illustrated in FIG. 6D, glass sheet 26 is separated from moving glass ribbon 20, and anvil assembly 28, scoring assembly 30 and nosing assembly 32 are withdrawn and returned to a starting position to begin another cycle.

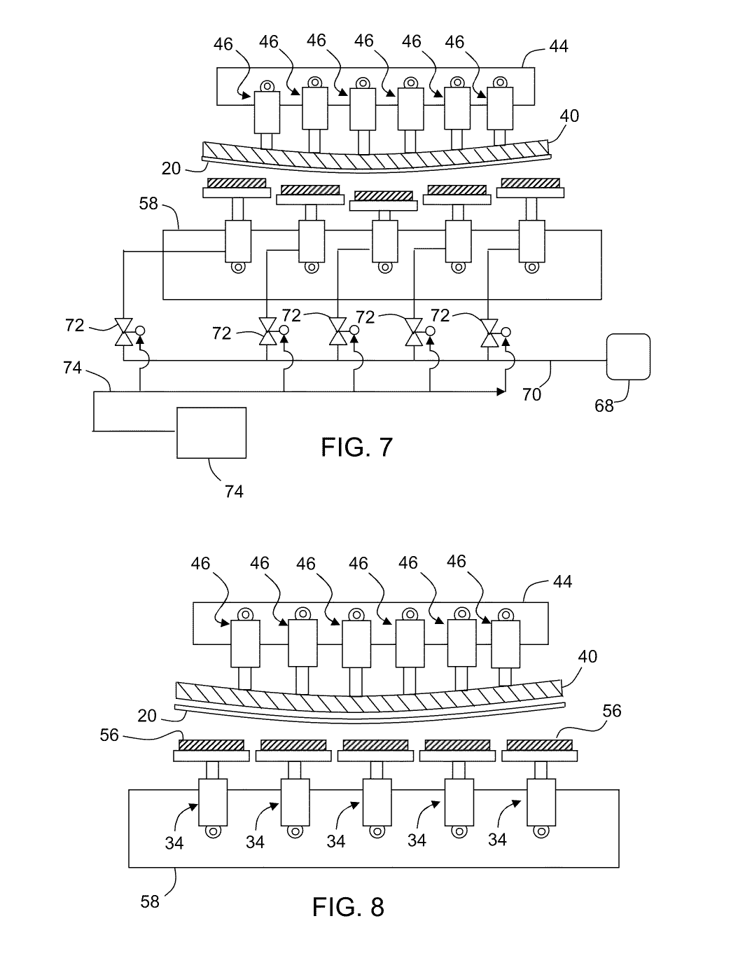

During the scoring operation the plurality of nosing contact members 56 are preferably not in contact with glass ribbon 20, but are instead positioned a predetermined distance from a surface of the ribbon. This predetermined distance between each nosing contact member and the second side of the moving glass ribbon may be different for each nosing contact member. For example, the glass ribbon at the cut off point (score line 50) may not be flat, but instead may exhibit curvature across at least a portion of the ribbon width. In some examples the ribbon may exhibit a longitudinal (in the direction of the downward movement of the ribbon) curvature as well as an across-the-ribbon curvature. The nosing contact members may be positioned in a complimentary fashion (mimicking the across-the-ribbon shape of the ribbon) as shown in FIG. 7, or in a non-complimentary fashion as shown in FIG. 8, depending on need. If the lateral motion of the glass ribbon after separation of the glass sheet is sufficiently large, the glass ribbon may contact one or more of the nosing contact members, depending on the position of each, and limit the magnitude of the lateral motion.

FIG. 7 also illustrates control mechanisms for the individual nosing members 34 of nosing assembly 32, including working fluid lines (e.g. gas or hydraulic fluid) extending from working fluid supply 68 and represented by line 70 including actuator valves 72. Actuator valves 72 may, for example, be remotely controlled by controller (or computer) 74 through control lines represented by control line 76. This allows each nosing member to be actuated independently of the other nosing members. This also provides nosing assembly 32 to be modular in design. That is, the foregoing configuration makes the addition or removal of individual nosing members to accommodate different width ribbon for example, a relatively easy task. The number of individual nosing members (and nosing contact members) is at least two, but could be 3, 4, 5, 6, 7, 8 or even ten or more individual nosing members depending on the width of the moving glass ribbon, the shape of the ribbon in a direction transverse to its draw direction, and the desired level of shape control or lateral movement limitation.

Once glass sheet 26 has been removed from moving glass ribbon 20 and lateral motion of glass ribbon 20 arrested, the nosing contact members 56 may be withdrawn and positioned upstream of scoring assembly 30 in anticipation of the separation of the subsequent individual sheet of glass. Once the nosing contact members have been repositioned, such as by first moving frame 58 outward, away from the ribbon, and upward to a docked placement above the scoring device, the nosing members are moved into their position wherein their respective nosing contact members 56 are adjacent to but not contacting the ribbon and the cycle begins again.

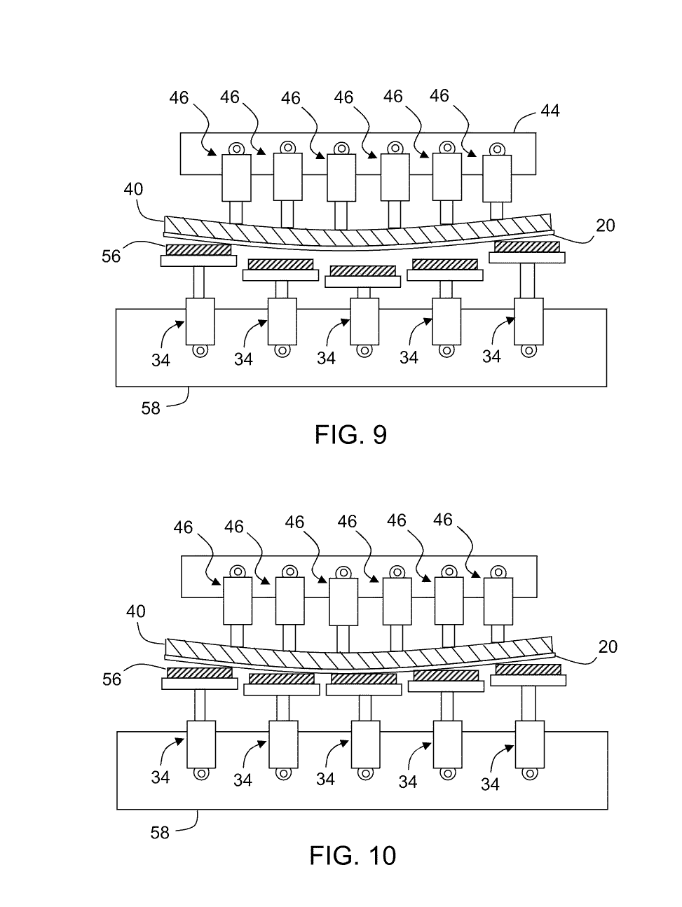

In some embodiments, one or more nosing contact members 56 may be engaged with second surface 38 of moving glass ribbon 20. That is, one or more nosing contact members may contact the moving glass ribbon during the scoring operation. Contact with the ribbon by the nosing contact members during the scoring operation can dampen vibration induced into the ribbon by the scoring. The nosing contact members may, for example, be positioned to present a shape to the ribbon that is complimentary to the across-the-width curvature of the ribbon. This curvature can be simple (e.g. a bow), or more complex, such as an “S” shape. Accordingly, some nosing contact members may be positioned to contact second surface 38 of glass ribbon 20 during the scoring operation while other nosing contact members are positioned a predetermined distance away from the ribbon during the scoring operation, as shown in FIG. 9. For example, nosing members located in an end position (at the outside longitudinal edges of the glass ribbon) may be actuated such that their respective nosing contact members 56 contact the ribbon during scoring to provide stiffness, but nosing members near the center of the glass ribbon may be actuated to position their respective nosing contact members a predetermined distance from the ribbon to serve as energy dampers and reduce perturbation during separation.

In yet another embodiment, all nosing contact members of the plurality of nosing contact members may be brought into contact with moving glass ribbon 20 during the scoring operation as the scoring member is traversed over second surface 38 of glass ribbon 20 across a width of the ribbon, as shown in FIG. 10.

Those skilled in the art will understand that while the description supra is directed to an exemplary fusion glass making process, the embodiments disclosed herein are applicable to other glass making processes, such as a slot draw process.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. For example, rather than independent carriages and frames as described herein, the components comprising the anvil assembly, scoring assembly and nosing assembly could all be mounted on a single carriage or framework that moves in a direction and at a speed that the moving ribbon of glass moves as it descends from the forming body, thus ensuring that each of the foregoing assemblies, and their associated components travel in unison and in synchronicity with the moving glass ribbon. All such modifications and variations are intended to be included herein within the scope of this disclosure and the present invention and protected by the following claims.

What is claimed is:

1. A method of separating a glass sheet from a moving ribbon of glass comprising:
forming a moving glass ribbon having first and second major sides in a downdraw process, the moving glass ribbon comprising a viscous portion and an elastic portion;
contacting the first side of the elastic portion of the moving ribbon of glass with an anvil contact member, the anvil contact member moving in a direction and at a speed equal to a direction and speed of the moving ribbon of glass;
positioning a plurality of nosing contact members adjacent to the second side of the moving ribbon of glass upstream from the anvil contact member;
scoring the second side of the moving glass ribbon across a width of the moving glass ribbon opposite the anvil contact member to form a score line in the second side of the moving glass ribbon;
separating a glass sheet from the moving glass ribbon at the score line by producing a tension stress across the score line; and
wherein each nosing contact member of the plurality of nosing contact members is positioned a predetermined distance from the moving glass ribbon so that none of the plurality of nosing contact members is in contact with the moving glass ribbon during the scoring, but such that lateral displacement of the moving ribbon of glass between the anvil contact member and the plurality of nosing contact members is constrained to a predetermined maximum during the separating.

2. The method according to claim 1, wherein the plurality of nosing contact members move in a direction and at a speed substantially equal to the direction and speed of the moving glass ribbon.

3. The method according to claim 1, wherein a maximum predetermined distance between the plurality of nosing contact members and the second side of the moving glass ribbon during the scoring is 5 mm.

4. The method according to claim 1, wherein producing a tensile stress across the score line comprises applying a bending stress to the moving glass ribbon.

5. The method according to claim 4, wherein each nosing contact member is positioned independently from another nosing contact member.

6. The method according to claim 1, wherein the plurality of nosing contact members are coupled to a frame and the positioning comprises moving the frame to simultaneously move the plurality of nosing contact members.

7. The method according to claim 1, wherein the plurality of nosing contact members are arrayed linearly across a width of the moving glass ribbon.

8. The method according to claim 1, wherein the plurality of nosing contact members are arrayed such that one nosing member of the plurality of nosing members is vertically offset from an adjacent nosing contact member.

9. A method of separating a glass sheet from a moving ribbon of glass comprising:
forming a moving glass ribbon having first and second major sides and comprising a viscous portion and an elastic portion;
contacting the first side of the elastic portion of the moving ribbon of glass with an anvil contact member, the anvil contact member moving in a direction and at a speed substantially equal to a direction and speed of the moving ribbon of glass;
positioning a plurality of nosing contact members adjacent to the second side of the moving ribbon of glass and upstream from the anvil contact member, the plurality of nosing contact members being arrayed across at least a portion of a width of the moving glass ribbon;
scoring the second side of the glass ribbon across a width of the glass ribbon opposite the anvil contact member to form a score line;
separating a glass sheet from the moving glass ribbon at the score line by producing a tensile stress across the score line; and
wherein at least one of the nosing contact members of the plurality of nosing contact members is in contact with the moving glass ribbon during the scoring.

10. The method according to claim 9, wherein the plurality of nosing contact members is arrayed in a non-linear array such that at least one nosing contact member of the plurality of nosing contact members is vertically offset from an adjacent nosing contact member in a direction the same as or opposed to the direction of the moving ribbon of glass.

11. The method according to claim 9, wherein at least one of the nosing contact members of the plurality of nosing contact members is not in contact with the moving ribbon of glass during the scoring.

12. The method according to claim 9, wherein all of the plurality of nosing contact members are in contact with the moving ribbon of glass during the scoring.

13. The method according to claim 9, wherein the positioning comprises moving each nosing contact member of the plurality of nosing contact members independently.

14. The method according to claim 9, wherein at least one nosing contact member of the plurality of nosing contact members contacts the moving glass ribbon after the separating.

15. The method according to claim 9, wherein the plurality of nosing contact members are arranged in a horizontal linear array.

16. The method according to claim 9, wherein the plurality of nosing contact members are arranged in a non-linear array such that one nosing contact member is vertically offset from an adjacent nosing contact member.

17. The method according to claim 9, wherein the plurality of nosing contact members are coupled to a frame and the positioning comprises moving the frame to position the plurality of nosing contact members simultaneously.

18. An apparatus for separating a sheet of glass from a moving glass ribbon comprising:
a forming body supplying a moving glass ribbon that transitions from a viscous state to an elastic state over a length of the ribbon;
an anvil contact member configured to move in a direction and at a speed substantially equal to a direction and speed of the moving ribbon of glass;
a plurality of individual nosing contact members arrayed across a width of the glass ribbon, each nosing contact member of the plurality of nosing contact members configured to move toward or away from the moving glass ribbon independently from an adjacent nosing contact member.

19. The apparatus according to claim 18, further comprising a carriage assembly coupled to the plurality of nosing contact members to move the plurality of nosing members in the direction and at the speed substantially equal to the direction and speed of the moving glass ribbon.

20. The apparatus according to claim 18, wherein the array of individual nosing contact members are arranged in a non-linear array across the width of the moving ribbon of glass.
